(19) United States
(12) Patent Application Publication
(10) Pub. No.: US 2024/0331253 A1
(43) Pub. Date: Oct. 3, 2024

(54) INFORMATION PROCESSING APPARATUS, METHOD FOR CONTROLLING INFORMATION PROCESSING APPARATUS, AND STORAGE MEDIUM

(71) Applicant: HONDA MOTOR CO., LTD., Tokyo (JP)

(72) Inventor: Yuji YASUI, Wako-shi (JP)

(21) Appl. No.: 18/615,332

(22) Filed: Mar. 25, 2024

(30) Foreign Application Priority Data
Mar. 31, 2023 (JP) 2023-059054

(51) Int. Cl. G06T 13/40; G05D 1/224

(52) U.S. Cl. CPC G06T 13/40; G05D 1/2245

(57) ABSTRACT

An information processing apparatus comprising: a control unit configured to control behavior of either a first avatar that is an avatar in a virtual space or a second avatar that is an avatar robot in a real space, based on a user operation; and a switching unit configured to switch between a first mode for displaying a virtual video of the virtual space and a second mode for displaying a real viewpoint video of the second avatar in the real space, based on the user operation.

### CROSS-REFERENCE TO RELATED APPLICATION(S)

This application claims priority to and the benefit of Japanese Patent Application No. 2023-059054, filed on Mar. 31, 2023, the entire disclosure of which is incorporated herein by reference.

### BACKGROUND OF THE INVENTION

### Field of the Invention

The present invention relates to an information processing apparatus, a method for controlling the information processing apparatus, and a storage medium.

### Description of the Related Art

Japanese Patent No. 6933849 discloses a technique for controlling, by a user who is present in a first area of a real space, a motion of a control target that is present in a second area of the real space, the second area being different from the first area in at least one of a time and a position.

In the technique described in Japanese Patent No. 6933849, however, there is an issue that it is difficult to switch between an avatar in a virtual space and an avatar in the real space.

### SUMMARY OF THE INVENTION

The present invention has been made in view of the above issue, and provides a technique for facilitating switching between avatars to be used by a user.

According to one aspect of the present invention, there is provided an information processing apparatus comprising: a control unit configured to control behavior of either a first avatar that is an avatar in a virtual space or a second avatar that is an avatar robot in a real space, based on a user operation; and a switching unit configured to switch between a first mode for displaying a virtual video of the virtual space and a second mode for displaying a real viewpoint video of the second avatar in the real space, based on the user operation.

Further features of the present invention will become apparent from the following description of exemplary embodiments with reference to the attached drawings.

### BRIEF DESCRIPTION OF THE DRAWINGS

FIG. 1 is a diagram illustrating a configuration example of an information processing system according to an embodiment;

FIG. 2A is a diagram illustrating a configuration example of a server apparatus (an information processing apparatus) according to an embodiment;

FIG. 2B is a diagram illustrating a configuration example of an avatar robot according to an embodiment;

FIG. 2C is a diagram illustrating a configuration example of a VR goggle device according to an embodiment;

FIG. 3A is a diagram illustrating a functional configuration example of a server apparatus (the information processing apparatus) according to an embodiment;

FIG. 3B is a diagram illustrating a functional configuration example of the avatar robot according to an embodiment;

FIG. 3C is a diagram illustrating a functional configuration example of the VR goggle device according to an embodiment;

FIG. 4 is a processing sequence diagram illustrating an example of transition processing from a first avatar in a virtual space to a second avatar in a real space according to an embodiment;

FIG. 5 is a flowchart illustrating a procedure of processing performed by the server apparatus (the information processing apparatus) according to an embodiment;

FIG. 6 is a processing sequence diagram illustrating an example of transition processing from the second avatar in the real space to the first avatar in the virtual space according to an embodiment;

FIG. 7 is a flowchart illustrating a procedure of processing performed by the server apparatus (the information processing apparatus) according to an embodiment;

FIG. 8 is an explanatory diagram of the transition processing from the first avatar in the virtual space to the second avatar in the real space according to an embodiment;

FIG. 9 is an explanatory diagram of the transition processing from the first avatar in the virtual space to the second avatar in the real space according to a first modification;

FIG. 10 is an explanatory diagram of the transition processing from the first avatar in the virtual space to the second avatar in the real space according to a second modification;

FIG. 11 is an explanatory diagram of the transition processing from the first avatar in the virtual space to the second avatar in the real space according to a third modification;

FIG. 12 is an explanatory diagram of the transition processing from the second avatar in the real space to the first avatar in the virtual space according to an embodiment;

FIG. 13 is an explanatory diagram of the transition processing from the second avatar in the real space to the first avatar in the virtual space according to a first modification;

FIG. 14 is an explanatory diagram of the transition processing from the second avatar in the real space to the first avatar in the virtual space according to a second modification;

FIG. 15 is an explanatory diagram of the transition processing from the second avatar in the real space to the first avatar in the virtual space according to a third modification;

FIG. 16 is an explanatory diagram of the transition processing from the second avatar in the real space to the first avatar in the virtual space according to a fourth modification;

FIG. 17 is an explanatory diagram of the transition processing from the second avatar in the real space to the first avatar in the virtual space according to a fifth modification;

FIG. 18 is an explanatory diagram of a direction that the first avatar faces after the transition processing according to the second to fifth modifications;

FIG. 19 is an explanatory diagram of a distance (in a case of being close) between the direction that the first avatar faces and another content display area after the transition processing according to the second to fifth modifications; and

FIG. 20 is an explanatory diagram of a distance (in a case of being far) between the direction that the first avatar faces and another content display area after the transition processing according to the second to fifth modifications.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### <System Configuration>

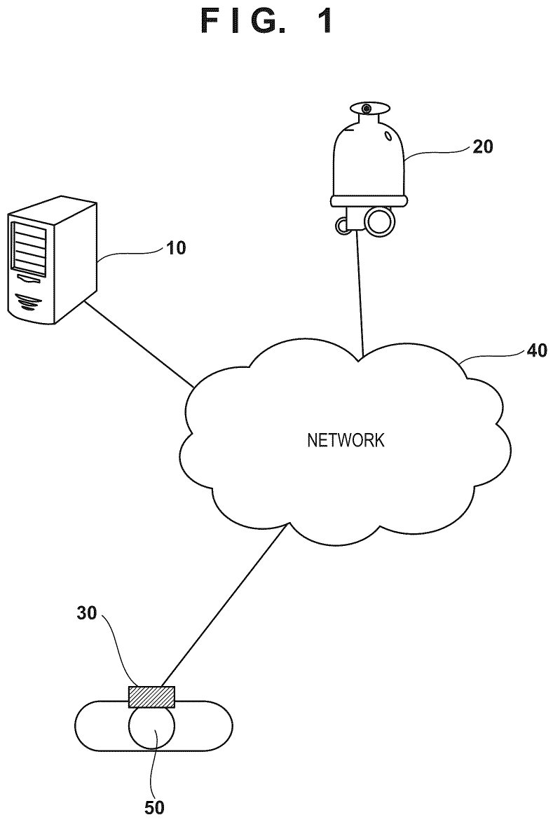

FIG. 1 is a diagram illustrating a configuration example of an information processing system according to the present embodiment. In FIG. 1, reference numeral 10 denotes a server apparatus (an information processing apparatus). Reference numeral 20 denotes an avatar robot. The avatar robot 20 is arranged in a real world (for example, a resort location), and is capable of freely moving in a predetermined range of the real world (for example, a range that is set as a movable area in the resort location), based on a user operation remotely. While checking a video imaged by the avatar robot 20, the user is able to remotely operate the avatar robot 20 to freely change the position of the avatar robot 20 and/or the direction that the avatar robot 20 faces and further an imaging direction (a viewpoint direction). By operating the avatar robot 20, the user is able to have experience, as if the user actually visited a remote real world.

Reference numeral 30 denotes a virtual reality (VR) goggle device 30. A user 50 wears the VR goggle device 30, and is able to freely operate a first avatar in a virtual space or a second avatar that is the avatar robot 20 in a real space, by visually recognizing various videos (for example, a video of a virtual space, a real viewpoint video of the avatar robot 20, and the like) and operating the VR goggle device 30 while viewing the displayed video. However, the display device is not limited to the VR goggle device 30, and may be a display such as a smartphone or a personal computer (PC), or may be a projection-type display that performs projection onto a wall or the like. Reference numeral 40 denotes a network. The server apparatus 10, the avatar robot 20, and the VR goggle device 30 are connected with one another through the network 40.

### <Apparatus Configuration>

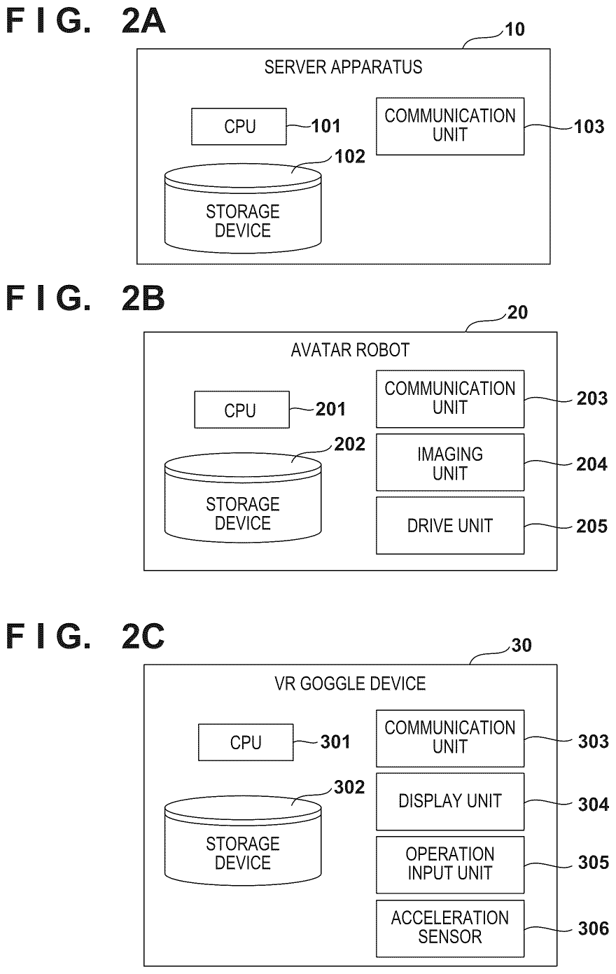

Next, configuration examples of the server apparatus 10, the avatar robot 20, and the VR goggle device 30 according to embodiments of the present invention will be described with reference to FIGS. 2A to 2C. FIG. 2A is a diagram illustrating a configuration example of the server apparatus 10 according to an embodiment of the present invention, FIG. 2B is a diagram illustrating a configuration example of the avatar robot 20 according to an embodiment of the present invention, and FIG. 2C is a diagram illustrating a configuration example of the VR goggle device 30 according to an embodiment of the present invention.

As illustrated in FIG. 2A, the server apparatus 10 includes a CPU 101, a storage device 102, and a communication unit 103. A control operation of the server apparatus 10 is achieved by the CPU 101 reading and executing a computer program stored in the storage device 102. The CPU 101 may be one or more CPUs. The storage device 102 is one or more memories that store several types of information. For example, information that has been received from another device, a computer program to be read and executed by the CPU 101, and the like are stored. The communication unit 103 has a function of communicating with another device in a wired or wireless manner through the network 40.

As illustrated in FIG. 2B, the avatar robot 20 includes a CPU 201, a storage device 202, a communication unit 203, an imaging unit 204, and a drive unit 205. A control operation of the avatar robot 20 is achieved by the CPU 201 reading and executing a computer program stored in the storage device 202. The CPU 201 may be one or more CPUs. The storage device 202 is one or more memories that store several types of information. For example, information that has been received from another device, a computer program to be read and executed by the CPU 201, and the like are stored. The communication unit 203 has a function of communicating with another device in a wired or wireless manner through the network 40.

The imaging unit 204 is a camera, and images a real viewpoint video of the avatar robot 20. The drive unit 205 drives wheels, not illustrated, included in the avatar robot 20. Accordingly, the avatar robot 20 is capable of moving in a front-and-rear direction, moving in a left-and-right direction, and rotationally moving on the spot, based on a remote operation by a user. In addition, the drive unit 205 is capable of changing an imaging direction of the imaging unit 204, based on a remote operation by the user.

As illustrated in FIG. 2C, the VR goggle device 30 includes a CPU 301, a storage device 302, a communication unit 303, a display unit 304, an operation input unit 305, and an acceleration sensor 306. A control operation of the VR goggle device 30 is achieved by the CPU 301 reading and executing a computer program stored in the storage device 302. The CPU 301 may be one or more CPUs. The storage device 302 is one or more memories that store several types of information. For example, information that has been received from another device, a computer program to be read and executed by the CPU 301, and the like are stored.

The communication unit 303 has a function of communicating with another device in a wired or wireless manner through the network 40. The display unit 304 displays various videos to the user 50. The operation input unit 305 receives an input of an instruction for operating the first avatar in the virtual space or the second avatar that is the avatar robot 20 in the real space. The acceleration sensor 306 detects acceleration applied to the VR goggle device 30.

The operation input unit 305 is capable of receiving a detection result of the acceleration sensor 306, as an input of an operation instruction. For example, by making a body stretching motion or a knee stretching motion, the user 50 wearing the VR goggle device 30 raises the avatar or gradually changes the avatar's visual line direction upward. By making a body bending motion or a knee bending motion, the user 50 lowers the avatar or gradually changes the avatar's visual line direction downward. By making a motion of rotating the head to the left, the user 50 rotates the avatar to the left. By making a motion of rotating the head to the right, the user 50 rotates the avatar to the right. By making a motion of tilting the head to the front, the user 50 moves the avatar forward. By making a motion of tilting the head to the rear, the user 50 moves the avatar backward. By making a motion of tilting the head to the left, the user 50 moves the avatar to the left. By making a motion of tilting the head to the right, the user 50 moves the avatar to the right.

Note that in the present embodiment, an example in which an operation input is received by a movement of the VR goggle device 30 itself will be described, but the operation input unit 305 is not limited to this example. For example, an operation input may be received by use of a device (a Joystick, a controller for gaming, an interactive seat, or the like) separate from the VR goggle device 30. The interactive sheet denotes a sheet that can receive an operation input by making various motions on a sheet portion while sitting on a chair. In such a case, such a separate device may be configured to communicate with the server apparatus 10 or the like.

### <Functional Configuration>

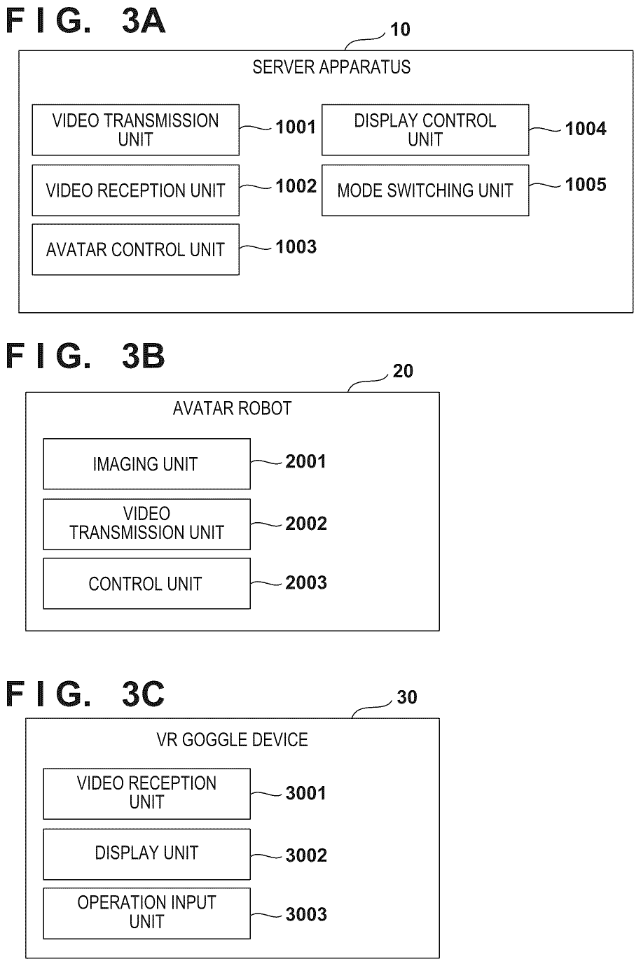

Next, functional configuration examples of the server apparatus 10, the avatar robot 20, and the VR goggle device 30 according to embodiments of the present invention will be described with reference to FIGS. 3A to 3C. FIG. 3A is a diagram illustrating a functional configuration example of the server apparatus 10 according to an embodiment of the present invention, FIG. 3B is a diagram illustrating a functional configuration example of the avatar robot 20 according to an embodiment of the present invention, and FIG. 3C is a diagram illustrating a functional configuration example of the VR goggle device 30 according to an embodiment of the present invention.

As illustrated in FIG. 3A, the server apparatus 10 includes a video transmission unit 1001, a video reception unit 1002, an avatar control unit 1003, a display control unit 1004, and a mode switching unit 1005. The video transmission unit 1001 transmits a video of the virtual space or a real viewpoint video of the avatar robot 20 in the real space to the VR goggle device 30. The video of the virtual space may be a bird's-eye view video in which the appearance of the avatar in the virtual space can be visually recognized, or may be a virtual viewpoint video of the avatar arranged in the virtual space. The video reception unit 1002 receives the real viewpoint video of the avatar robot 20 in the real space from the avatar robot 20.

The avatar control unit 1003 controls behavior of the first avatar that is the avatar in the virtual space or the second avatar that is the avatar robot 20 in the real space, based on a user operation using the operation input unit 305. The display control unit 1004 controls a video displayed on the display unit 304 of the VR goggle device 30. The mode switching unit 1005 switches between a first mode for displaying a virtual video of the virtual space and a second mode for displaying a real viewpoint video of the second avatar that is the avatar robot 20 in the real space, based on a user operation.

As illustrated in FIG. 3B, the avatar robot 20 includes an imaging unit 2001, a video transmission unit 2002, and a control unit 2003. The imaging unit 2001 is provided, for example, in the vicinity of the head of the avatar robot 20, and images a video on a forward side of the avatar robot 20. The video imaged by the imaging unit 2001 is the real viewpoint video of the avatar robot 20. The video transmission unit 2002 transmits the real viewpoint video of the avatar robot 20 that has been imaged by the imaging unit 2001 to the server apparatus 10. The control unit 2003 controls a movement, a change in the visual line direction, and the like of the avatar robot 20, based on the control by the avatar control unit 1003 of the server apparatus 10.

As illustrated in FIG. 3C, the VR goggle device 30 includes a video reception unit 3001, a display unit 3002, and an operation input unit 3003. The video reception unit 3001 receives the virtual video of the virtual space from the server apparatus 10, and receives the real viewpoint video of the avatar robot 20 via the server apparatus 10. The display unit 3002 displays, for the user 50, the video that has been received by video reception unit 3001. The operation input unit 3003 receives an input of an instruction to operate the first avatar that is the avatar in the virtual space or the second avatar that is the avatar robot 20 in the real space.

<Transition from First Avatar in Virtual Space to Second Avatar in Real Space>

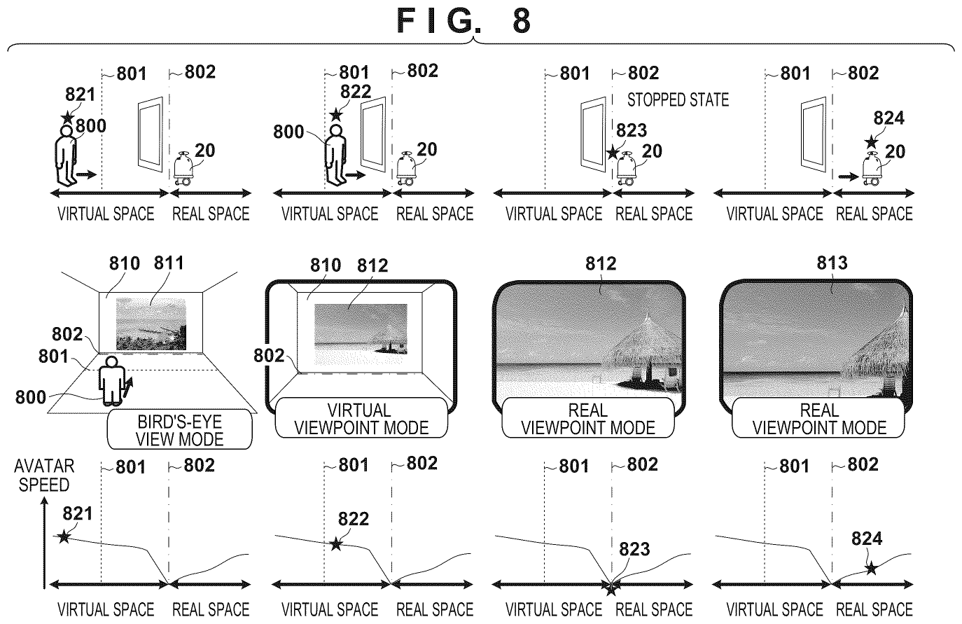

FIG. 8 is an explanatory diagram of transition processing from the first avatar in the virtual space to the second avatar in the real space according to the present embodiment. The top row of FIG. 8 illustrates changes in the position of the first avatar in the virtual space and the position of the second avatar in the real space. The middle row of FIG. 8 illustrates changes in the display video on the display unit 3002 of the VR goggle device 30 worn by the user 50 in response to a change in the position of the avatar. The bottom row of FIG. 8 illustrates relationships between a moving speed (a vertical axis) of the avatar and changes in the position of the first avatar in the virtual space and the position of the second avatar in the real space.

As illustrated in the first one from the left in the middle row of FIG. 8, the virtual video is displayed on the display unit 3002 of the VR goggle device 30 in the first mode for displaying the virtual video in the virtual space. Note that the first mode can include a bird's-eye view mode for displaying a virtual video including a first avatar 800 in the virtual space, and a virtual viewpoint mode for displaying a virtual video viewed from a virtual viewpoint of the first avatar 800, and the virtual video is displayed in either mode. In the first one from the left in the middle row of FIG. 8, the virtual video is displayed in the bird's-eye view mode, and the first avatar 800 can be observed in the virtual space.

The virtual space is, for example, a space such as a room, and an image 811 of a place where the second avatar (the avatar robot 20) is present is superimposed and displayed on at least a part of a wall area 810, which is a predetermined area of the virtual video. Note that the image 811 may not necessarily be the real viewpoint video of the avatar robot 20, and may be a still image related to the place where the avatar robot 20 is present. In the illustrated example, an image of a landscape of a resort location is superimposed and displayed.

The user 50 is able to operate the operation input unit 3003 of the VR goggle device 30 to operate the first avatar 800 and freely move the first avatar 800 in the virtual space. The user 50 operates the operation input unit 3003 to make a specific motion for a predetermined area (a display area of the image 811, which is at least a partial area of the wall area 810), thereby switching from the first mode to the second mode.

As the specific motion, the user 50 makes a motion of causing the first avatar 800 to get close to the position of the predetermined area to have a threshold distance (a position 801, which is apart from a position 802 where the image 811 is displayed). When the first avatar reaches the position 801 from a position 821, first, viewpoint switching processing from the bird's-eye view mode in the first mode to the virtual viewpoint mode in the first mode is performed. Accordingly, the virtual video is displayed in the virtual viewpoint mode as in the second one from the left in the middle row of FIG. 8, and the video from the viewpoint of the first avatar 800 is displayed. At this timing, a display content of the predetermined area (an image display area) is changed from the image 811 of the place where the avatar robot 20 that is the second avatar is present to a real viewpoint video 812 of the second avatar. Then, as the specific motion, by making a motion of causing the first avatar 800 to get closer to the display position (the position 802) of the predetermined area (the image display area) from the position 801, the first avatar 800 automatically decelerates toward the position 802. Then, the first avatar 800 moves toward the position 802 so that the moving speed becomes zero at the position 802.

When the first avatar 800 reaches the position 802, switching to the second mode for displaying the real viewpoint video of the second avatar that is the avatar robot 20 in the real space is performed, and the real viewpoint video 812 is displayed on the display unit 3002 of the VR goggle device 30, as illustrated in the third one from the left in the middle row of FIG. 8. Accordingly, it is possible to transition from the first avatar 800 in the virtual space to the second avatar that is the avatar robot 20. At the time of transition, the avatar robot 20 is in a stopped state, and the real viewpoint video 812 is displayed. After the transition, the user 50 is able to operate the operation input unit 3003 of the VR goggle device 30 to move the avatar robot 20. As illustrated in the fourth one from the left in the middle row of FIG. 8, the position of the avatar robot 20 has changed from a position 823 to a position 824 in response to a user operation, and thus the display video changes as in a real viewpoint video 813. By operating the second avatar that is the avatar robot 20, the user 50 is able to freely move the avatar robot 20 within a range of the movable area in the real space where the avatar robot 20 is capable of moving, and is able to visually recognize the real viewpoint video. Accordingly, the user is able to have experience as if the user actually visited the place (for example, a resort location) where the avatar robot 20 is present via the real viewpoint video of the avatar robot 20.

### <Processing>

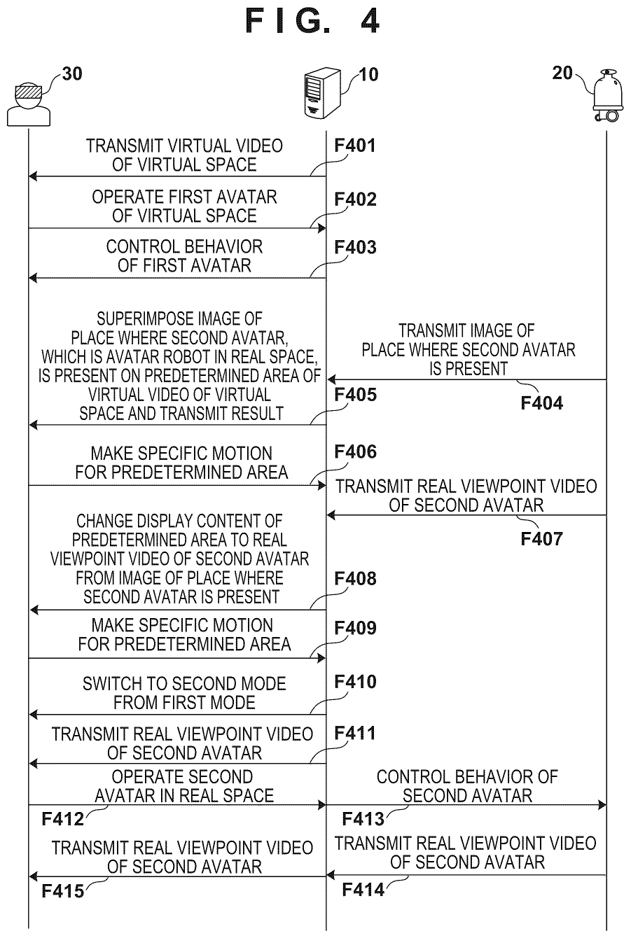

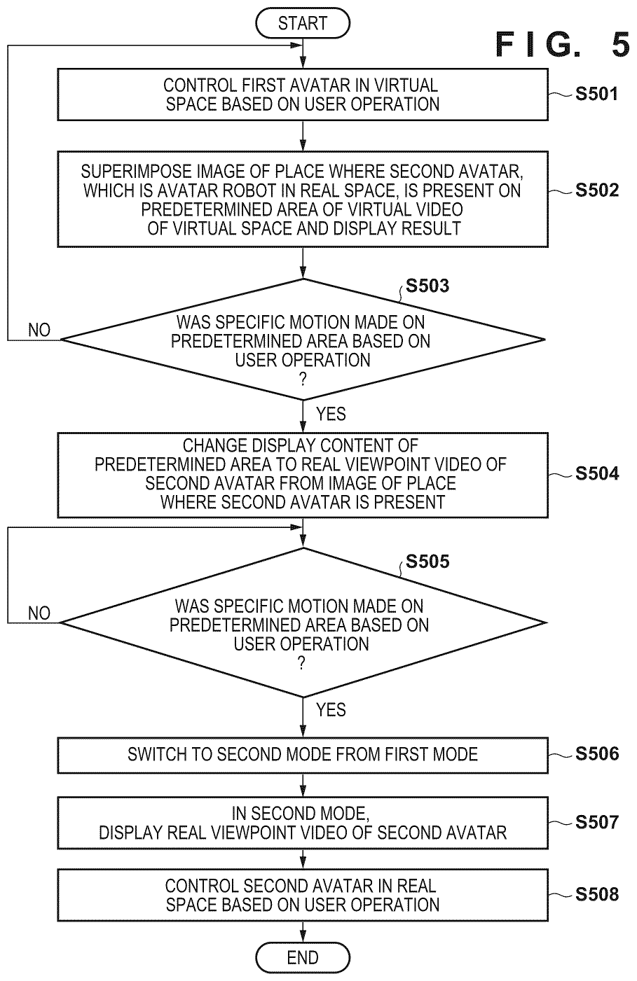

Next, transition processing from the first avatar in the virtual space to the second avatar in the real space according to the present embodiment will be described with reference to a processing sequence diagram of FIG. 4, a flowchart of FIG. 5, and FIG. 8.

First, in F401 of FIG. 4, the server apparatus 10 transmits the virtual video of the virtual space to the VR goggle device 30. In F402, the VR goggle device 30 operates the first avatar in the virtual space, based on an operation of the user 50. In F403, the server apparatus 10 controls behavior of the first avatar in the virtual space, and transmits the virtual video of the virtual space in which the content of an operation of the user 50 has been reflected to the VR goggle device 30.

In F404, the avatar robot 20 transmits an image of the place where the second avatar (the avatar robot 20) is present to the server apparatus 10. For example, the avatar robot 20 transmits a still image (for example, an image of a landscape of a resort location) related to the place where the avatar robot 20 is present. Note that the processing of F404 may be performed beforehand, and the server apparatus 10 may hold the image.

In F405, the server apparatus 10 superimposes the image of the place where the second avatar (the avatar robot 20) is present in the real space (for example, the image of the landscape of the resort location) on a predetermined area (in the example of FIG. 8, the image display area 811 provided in at least a part of the wall area 810 in the virtual space) of the virtual video of the virtual space, and transmits the superimposed image.

In F406, the VR goggle device 30 makes a specific motion on the predetermined area, based on an operation of the user 50. In the example of FIG. 8, the specific motion here is a motion of causing the first avatar 800 to get close to the position of the predetermined area to have a threshold distance (the position 801, which is apart from the position 802 where the image 811 is displayed).

In F407, the avatar robot 20 transmits the real viewpoint video of the second avatar (the avatar robot 20) to the server apparatus 10. The processing may be performed in response to the server apparatus 10 notifying the avatar robot 20 that the specific motion has been made. Alternatively, the real viewpoint video of the second avatar (the avatar robot 20) may be transmitted to the server apparatus 10 all the time.

In F408, the server apparatus 10 changes the display content of the predetermined area from the image of the place where the second avatar (the avatar robot 20) is present to the real viewpoint video of the second avatar. In F409, the VR goggle device 30 makes a specific motion on the predetermined area, based on an operation of the user 50. In the example of FIG. 8, the specific motion here is a motion of causing the first avatar 800 to get close to the position 802, which is the display position of the predetermined area (the image display area).

In F410, the server apparatus 10 switches from the first mode to the second mode. Accordingly, the first avatar in the virtual space is transitioned to the second avatar in the real space. In F411, the server apparatus 10 transmits the real viewpoint video of the second avatar (the avatar robot 20) to the VR goggle device 30 to display the real viewpoint video. In the example of FIG. 8, the VR goggle device 30 displays the real viewpoint video 812.

In F412, the VR goggle device 30 operates the second avatar in the real space, based on the content of an operation of the user 50. In F413, the server apparatus 10 controls behavior of the second avatar in the real space. In F414, the avatar robot 20 transmits, to the server apparatus 10, the real viewpoint video (the real viewpoint video 813 in the example of FIG. 8) in which the content of the operation of the user 50 has been reflected.

In F415, the server apparatus 10 transmits the real viewpoint video (the real viewpoint video 813 in the example of FIG. 8) in which the content of the operation of the user 50 has been reflected to the VR goggle device 30 to display the real viewpoint video. Heretofore, the processing sequence of FIG. 4 ends.

Next, FIG. 5 is a flowchart illustrating a procedure of processing performed by the server apparatus (the information processing apparatus) according to the present embodiment. The processing starts in a state of the first mode for displaying the virtual video of the virtual space.

In S501, the avatar control unit 1003 of the server apparatus 10 controls the first avatar in the virtual space, based on a user operation on the VR goggle device 30. In S502, the display control unit 1004 of the server apparatus 10 superimposes and displays the image of the place where the second avatar that is the avatar robot 20 in the real space is present (the image 811 in the example of FIG. 8), on a predetermined area in the virtual video of the virtual space.

In S503, the mode switching unit 1005 of the server apparatus 10 determines whether a specific motion has been made on the predetermined area, based on the user operation on the VR goggle device 30. In the example of FIG. 8, the specific motion here is a motion of causing the first avatar 800 to get close to the position of the predetermined area to have a threshold distance (the position 801, which is apart from the position 802 where the image 811 is displayed). In a case where this step is Yes, the processing proceeds to S504, whereas in a case where this step is No, the processing returns to S501.

In S504, the display control unit 1004 of the server apparatus 10 changes the display content of the predetermined area from the image of the place where the second avatar is present to the real viewpoint video of the second avatar. In the example of FIG. 8, the image 811 displayed in a part of the wall area 810 is changed to the real viewpoint video 812. By getting closer to the wall area 810, the image is switched to the real viewpoint video 812. Therefore, expectations for virtual experience using the avatar robot 20 can be increased.

In S505, the mode switching unit 1005 of the server apparatus 10 determines whether a specific motion has been made on the predetermined area, based on the user operation on the VR goggle device 30. In the example of FIG. 8, the specific motion here is a motion of causing the first avatar 800 to get close to the position 802, which is the display position of the predetermined area (the image display area). In a case where this step is Yes, the processing proceeds to S506, whereas in a case where this step is No, the processing awaits. Alternatively, in a case of moving in a direction away in an opposite way without moving from the position 801 to the position 802, the processing may return to S502.

In S506, the mode switching unit 1005 of the server apparatus 10 switches from the first mode for displaying the virtual video of the virtual space to the second mode for displaying the real viewpoint video of the second avatar that is the avatar robot 20 in the real space. In S507, in the second mode, the display control unit 1004 of the server apparatus 10 transmits the real viewpoint video of the second avatar (the avatar robot 20) to the VR goggle device 30 to display the real viewpoint video. In S508, the avatar control unit 1003 of the server apparatus 10 controls the second avatar (the avatar robot 20) in the real space, based on a user operation on the VR goggle device 30. Heretofore, the processing of FIG. 5 ends.

As described heretofore, according to the present embodiment, it is possible to easily switch from the first mode for displaying the virtual video of the virtual space to the second mode for displaying the real viewpoint video of the second avatar in the real space.

[First Modification (Transition from First Mode to Second Mode)]

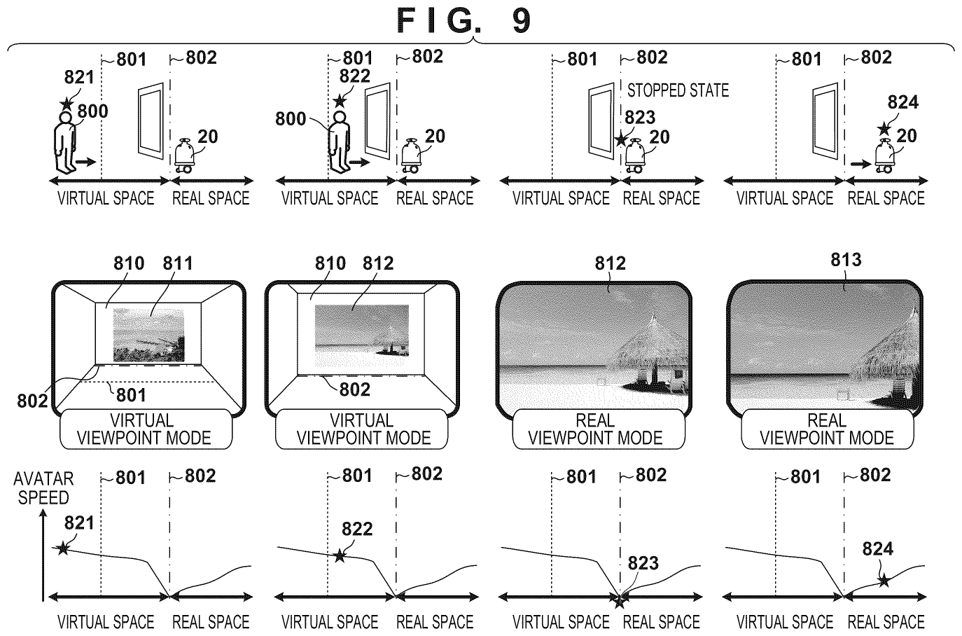

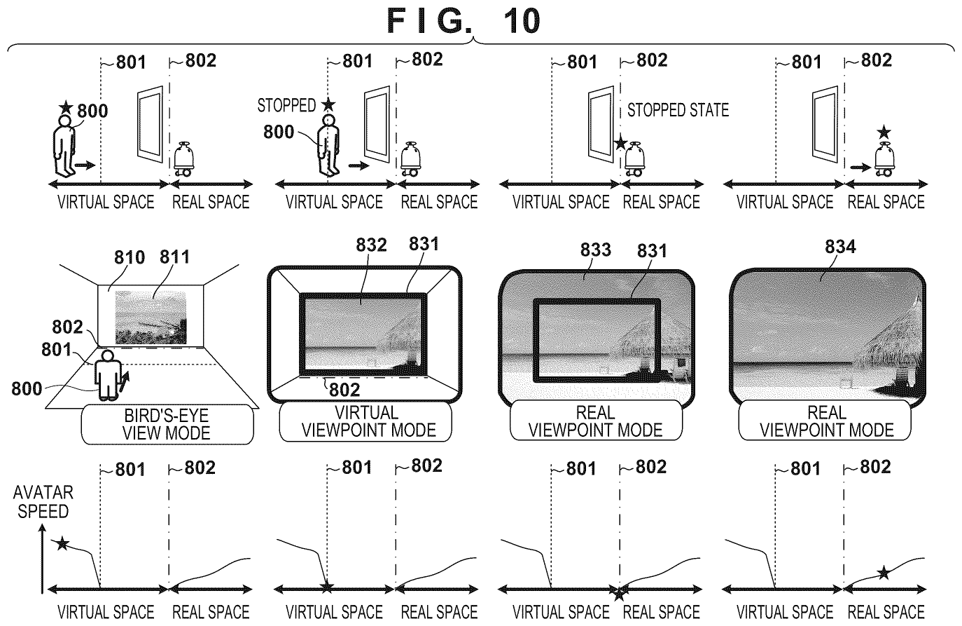

FIG. 9 is an explanatory diagram of transition processing from the first avatar in the virtual space to the second avatar in the real space according to a first modification. A display method of the virtual video in the first one from the left in the middle row of FIG. 9 is different from that in FIG. 8. In the example of FIG. 8, the example of displaying the virtual video in the bird's-eye view mode of the first mode has been described. However, the virtual video may be displayed in the virtual viewpoint mode of the first mode as illustrated in FIG. 9. In this case, even when the first avatar 800 reaches the position 801, the bird's-eye view mode is not switched to the virtual viewpoint mode as in FIG. 8. In this case, it is possible to configure to perform processing similar to the description of FIG. 8 in response to further getting closer to the position 802 beyond the position 801.

[Second Modification (Transition from First Mode to Second Mode)]

FIG. 10 is an explanatory diagram of transition processing from the first avatar in the virtual space to the second avatar in the real space according to a second modification. In FIG. 10, a display method of the virtual video in the first one from the left in the middle row is the bird's-eye view mode similarly to FIG. 8. In FIG. 10, unlike FIG. 8, by making a motion to cause the first avatar 800 to get close to the position 801, the first avatar 800 decelerates as it is getting closer to the position 801, and the first avatar 800 automatically stops moving at the position 801. Alternatively, the user 50 may perform an operation of causing the first avatar 800 to move decelerating to the position 801 and stop at the position 801. The bird's-eye view mode is switched to the virtual viewpoint mode similarly to the example of FIG. 8, based on the first avatar 800 stopping at the position 801.

In the present second modification, the first mode is switched to the second mode without the first avatar 800 getting close to the position 802 in the wall area. Before the first mode is switched to the second mode, a real viewpoint video 832, which is a part of a real viewpoint video 833 of the avatar robot 20, is displayed in a predetermined area of the virtual video (for example, in a frame 831 of the wall area), as in the virtual video in the second one from the left in the middle row of FIG. 10. Then, after the first mode is switched to the second mode, the real viewpoint video 833 of the avatar robot 20 is displayed. In such a situation, the real viewpoint video 833 is displayed including the real viewpoint video 832. The frame 831 is superimposed and displayed for the sake of description. However, only the real viewpoint video 833 is displayed, and the frame 831 is not displayed.

In such a situation, the real viewpoint video 832, which is a part of the real viewpoint video 833, is controlled to be displayed on the same position in the display unit 3002. That is, before and after the first mode is transitioned to the second mode, the transition is performed so as not to change the display position of the real viewpoint video 832. In this manner, mode switching is performed, while maintaining a change amount in the visual information of the user 50 to be equal to or smaller than a predetermined value. Accordingly, it is possible to suppress the field of view from largely changing from the real viewpoint video 832, and thus it becomes possible to avoid giving the user 50 a sense of incongruity at the time of mode transition.

Then, after the first mode is switched to the second mode, the user 50 is able to operate the VR goggle device 30 to freely move the avatar robot 20 and view a real viewpoint video 834.

Note that in the present second modification, the real viewpoint video 832 of a part of the real viewpoint video of the avatar robot 20 is displayed in the entire wall area. However, without being limited to the example of displaying the real viewpoint video in the entire wall area, the real viewpoint video may be displayed in a part of the wall area.

[Third Modification (Transition from First Mode to Second Mode)]

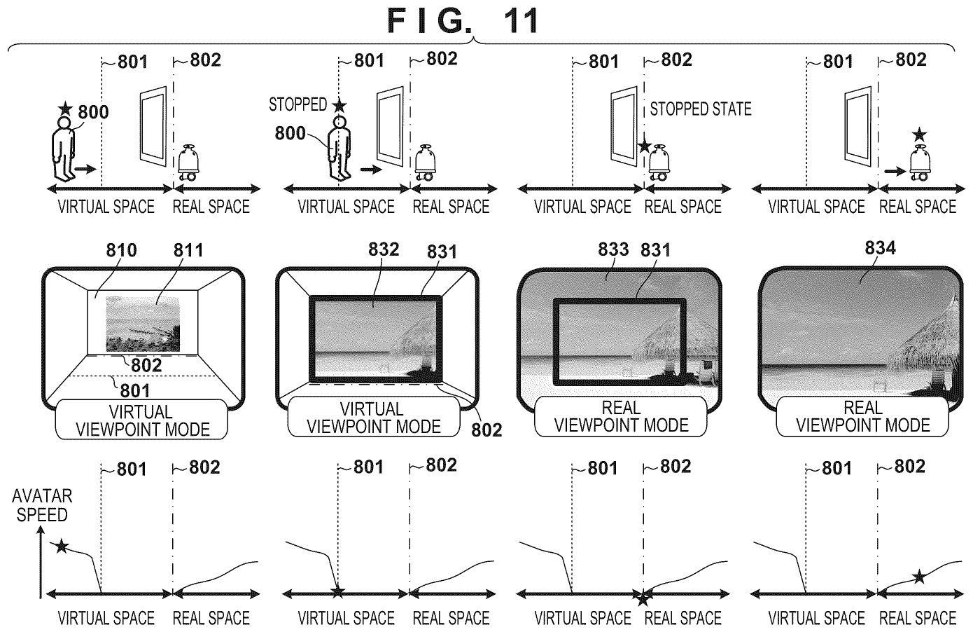

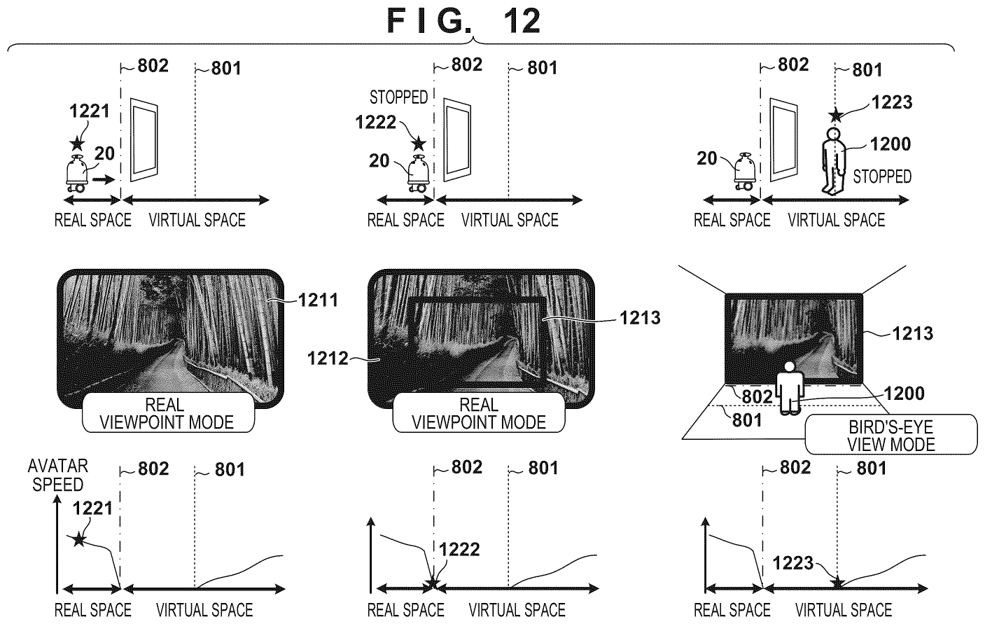

FIG. 11 is an explanatory diagram of transition processing from the first avatar in the virtual space to the second avatar in the real space according to a third modification. A display method of the virtual video in the first one from the left in the middle row of FIG. 11 is different from that in FIG. 10. In the example of FIG. 10, the example of displaying the virtual video in the bird's-eye view mode of the first mode has been described. However, the virtual video may be displayed in the virtual viewpoint mode of the first mode as illustrated in FIG. 11. In this case, the bird's-eye view mode is not switched to the virtual viewpoint mode, even when the first avatar 800 reaches the position 801. In this case, similarly to FIG. 10, by making a motion to cause the first avatar 800 to get close to the position 801, the first avatar 800 decelerates as it is getting closer to the position 801, and the first avatar 800 stops moving at the position 801. The subsequent processing is similar to that of the second modification that has been described with reference to FIG. 10.

<Transition from Second Avatar in Real Space to First Avatar in Virtual Space>

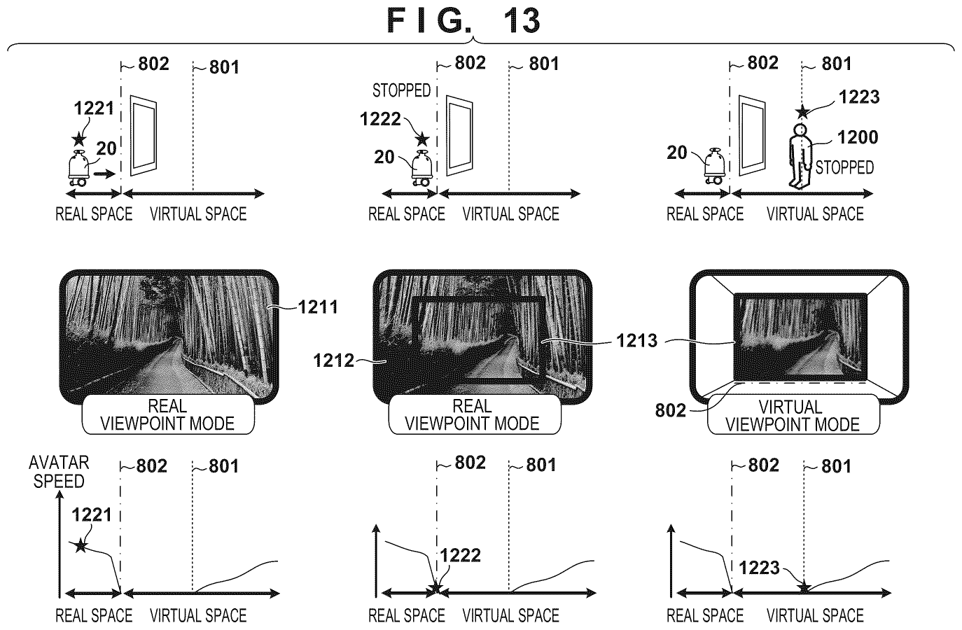

Subsequently, FIG. 12 is an explanatory diagram of transition processing from the second avatar in the real space to the first avatar in the virtual space according to the present embodiment. The top row of FIG. 12 illustrates changes in the position of the second avatar in the real space and the position of the first avatar in the virtual space. The middle row of FIG. 12 illustrates changes in the display video on the display unit 3002 of the VR goggle device 30 worn by the user 50 in response to a change in the position of the avatar. The bottom row of FIG. 12 illustrates relationships between a moving speed (a vertical axis) of the avatar and changes in the position of the second avatar in the real space and the position of the first avatar in the virtual space.

As illustrated in the first one from the left in the middle row of FIG. 12, in the second mode for displaying the real viewpoint video of the second avatar that is the avatar robot 20 in the real space, a real viewpoint video 1211 is displayed on the display unit 3002 of the VR goggle device 30. In the illustrated example, a video of a road that passes through a bamboo forest is displayed.

The user 50 operates the operation input unit 3003 of the VR goggle device 30, and operates the second avatar (the avatar robot 20) to be capable of freely moving in an area within a predetermined range in the real space. By operating the operation input unit 3003 to make a specific motion, the user 50 is able to switch from the second mode to the first mode. The specific motion here includes a motion to cause the avatar robot 20 to get close to a boundary position of its movable area. When the avatar robot 20 moves from a position 1221 and gets close to a position 1222 corresponding to the boundary position, control is conducted to stop the avatar robot 20. At this timing, as illustrated in the second one from the left in the middle row of FIG. 12, a real viewpoint video 1212 (including a real viewpoint video 1213) is displayed.

Then, the second mode is transitioned to the first mode in response to an operation on the operation input unit 3003 of the VR goggle device 30 to press a predetermined button or make a motion to move the avatar robot 20 in a direction in which it is not capable of moving any more (in a further outward direction of the boundary position).

As illustrated in the third one from the left in the middle row of FIG. 12, the virtual video of the virtual space in (the bird's-eye view mode of) the first mode is displayed on the display unit 3002 of the VR goggle device 30. A first avatar 1200 in the virtual space is present at a position 1223, and the first avatar 1200 is displayed in a controlled state to face the wall area.

In this situation, the real viewpoint video 1213, which is a part of the real viewpoint video 1212, is controlled to be displayed on the same position in the display unit 3002. That is, before and after the second mode is transitioned to the first mode, the transition is performed so as not to change the display position of the real viewpoint video 1213. Accordingly, it is possible to suppress the field of view from largely changing from the real viewpoint video 1213, and thus it becomes possible to avoid giving the user 50 a sense of incongruity at the time of mode transition. In addition, a virtual video part of the virtual space other than the real viewpoint video 1213 may be displayed in a fade-in motion. Accordingly, the user 50 is able to recognize that the user has returned to the virtual space without a sense of incongruity, while a sudden change from the real viewpoint video is being suppressed.

Thereafter, the user 50 operates the first avatar 1200 in the virtual space, and is able to freely move in the virtual space. Accordingly, the user is able to have experience, as if the user actually visited the place where the avatar robot 20 is present (for example, the road that passes through the bamboo forest) via the real viewpoint video of the avatar robot 20, and then is able to have experience of returning to the virtual space of the user.

### <Processing>

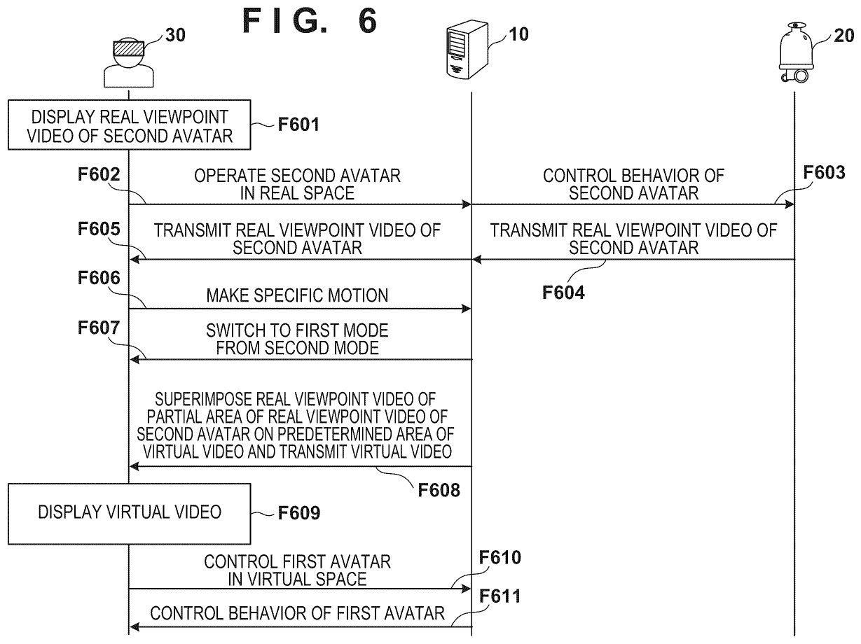

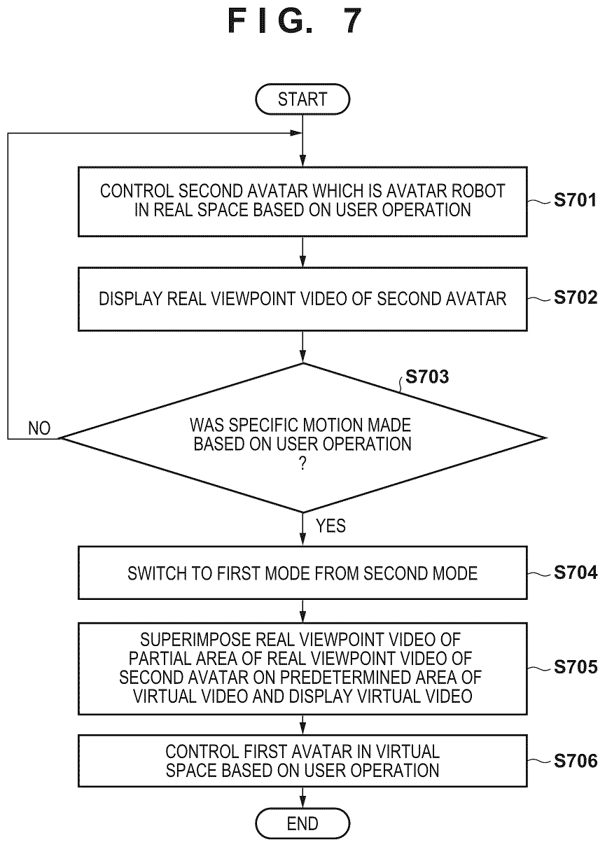

Next, transition processing from the second avatar in the real space to the first avatar in the virtual space according to the present embodiment will be described with reference to a processing sequence diagram of FIG. 6, a flowchart of FIG. 7, and FIG. 12.

First, in F601 of FIG. 6, the VR goggle device 30 displays the real viewpoint video of the second avatar (the avatar robot 20) that has been received from the server apparatus 10. In F602, the VR goggle device 30 operates the second avatar (the avatar robot 20), based on an operation of the user 50. In F603, the server apparatus 10 controls behavior of the second avatar (the avatar robot 20) in the real space.

In F604, the avatar robot 20 transmits the real viewpoint video of the second avatar (the avatar robot 20) to the server apparatus 10. In F605, the server apparatus 10 transmits the real viewpoint video of the second avatar (the avatar robot 20) to the VR goggle device 30 to display the real viewpoint video. In F606, the VR goggle device 30 makes a specific motion, based on an operation of the user 50. In the example of FIG. 12, the specific motion here is a motion to cause the avatar robot 20 to get close to the boundary position of its movable area. In F607, the server apparatus 10 switches from the second mode to the first mode.

In F608, the server apparatus 10 superimposes the real viewpoint video of a partial area of the real viewpoint video of the second avatar (the avatar robot 20) on a predetermined area of the virtual video, and transmits the virtual video to the VR goggle device 30. In F609, the VR goggle device 30 displays the virtual video that has been received. In the example of FIG. 12, in (the bird's-eye view mode of) the first mode, the real viewpoint video 1213 of a partial area of the real viewpoint video 1212 is superimposed and displayed on the wall area. In this situation, the real viewpoint video 1213, which is a part of the real viewpoint video 1212, is controlled to be displayed on the same position in the display unit 3002. That is, before and after the second mode is transitioned to the first mode, the transition is performed so as not to change the display position of the real viewpoint video 1213.

In F610, the VR goggle device 30 operates the first avatar (the first avatar 1200 in the example of FIG. 12) in the virtual space, based on an operation of the user 50. In F611, the server apparatus 10 controls behavior of the first avatar in the virtual space, and transmits the virtual video of the virtual space, in which the content an operation of the user 50 has been reflected, to the VR goggle device 30. Heretofore, the processing sequence of FIG. 6 ends.

Next, FIG. 7 is a flowchart illustrating a procedure of processing performed by the server apparatus (the information processing apparatus) according to the present embodiment. The processing starts in the second mode for displaying the real viewpoint video of the second avatar that is the avatar robot 20 in the real space.

In S701, the avatar control unit 1003 of the server apparatus 10 controls the second avatar that is the avatar robot 20 in the real space, based on a user operation on the VR goggle device 30. In S702, the display control unit 1004 of the server apparatus 10 transmits the real viewpoint video of the second avatar (the avatar robot 20) that has been received from the avatar robot 20 to the VR goggle device 30 to display the real viewpoint video.

In S703, the mode switching unit 1005 of the server apparatus 10 determines whether a specific motion has been made, based on a user operation on the VR goggle device 30. In the example of FIG. 12, the specific motion here is a motion to cause the avatar robot 20 to get close to the boundary position of its movable area. In a case where this step is Yes, the processing proceeds to S704, whereas in a case where this step is No, the processing returns to S701.

In S704, the mode switching unit 1005 of the server apparatus 10 switches from the second mode for displaying the real viewpoint video of the second avatar (the avatar robot 20) in the real space to the first mode for displaying the virtual video of the virtual space.

In S705, the display control unit 1004 of the server apparatus 10 superimposes the real viewpoint video of a partial area of the real viewpoint video of the second avatar (the avatar robot 20) on a predetermined area of the virtual video, and transmits the superimposed video to the VR goggle device 30 to display the superimposed video. In the example of FIG. 12, in (the bird's-eye view mode of) the first mode, the real viewpoint video 1213 of a partial area of the real viewpoint video 1212 is superimposed and displayed on the wall area. In this situation, the real viewpoint video 1213, which is a part of the real viewpoint video 1212, is controlled to be displayed on the same position in the display unit 3002. That is, before and after the second mode is transitioned to the first mode, the transition is performed so as not to change the display position of the real viewpoint video 1213.

In S706, the avatar control unit 1003 of the server apparatus 10 controls the first avatar in the virtual space, based on a user operation on the VR goggle device 30. Heretofore, the processing of FIG. 7 ends.

As described heretofore, according to the present embodiment, it is possible to easily switch from the second mode for displaying the real viewpoint video of the second avatar in the real space to the first mode for displaying the virtual video of the virtual space.

[First Modification (Transition from Second Mode to First Mode)]

FIG. 13 is an explanatory diagram of transition processing from the second avatar in the real space to the first avatar in the virtual space according to a first modification. A display method of the virtual video in the third one from the left in the middle row of FIG. 13 is different from that in FIG. 12. In the example of FIG. 12, the example of displaying the virtual video in the bird's-eye view mode of the first mode has been described. However, the virtual video may be displayed in the virtual viewpoint mode of the first mode as illustrated in FIG. 13.

[Second Modification (Transition from Second Mode to First Mode)]

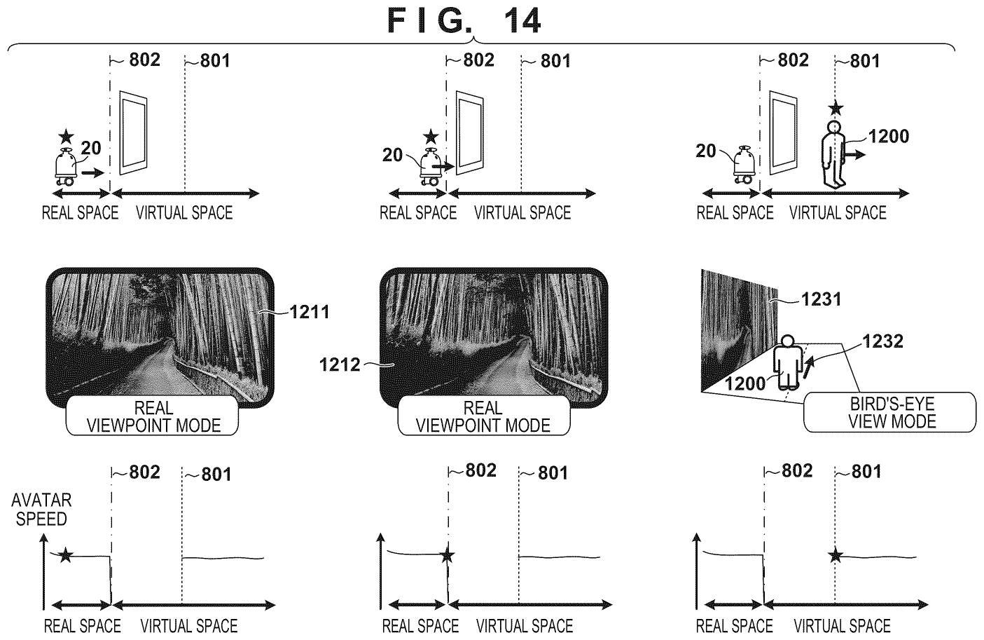

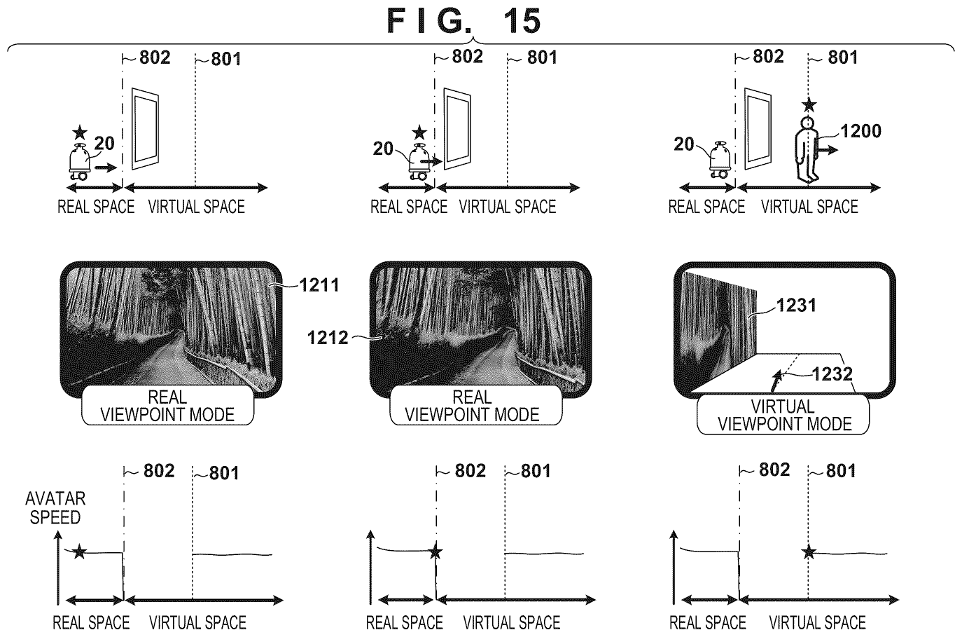

FIG. 14 is an explanatory diagram of transition processing from the second avatar in the real space to the first avatar in the virtual space according to a second modification. In FIG. 14, unlike the example of FIG. 12, a motion is made to cause the avatar robot 20 to get close to the position 802 at a substantially constant moving speed. The second mode is switched to the first mode in response to the avatar robot 20 having gotten close to and reached the position 802. The avatar robot 20 automatically stops in response to having reached the position 802. Then, when transitioning to the first avatar 1200 in the virtual space is performed, a direction 1232 of the virtual viewpoint of the virtual video is controlled not to face toward the wall area that is the display area of a real viewpoint video 1231.

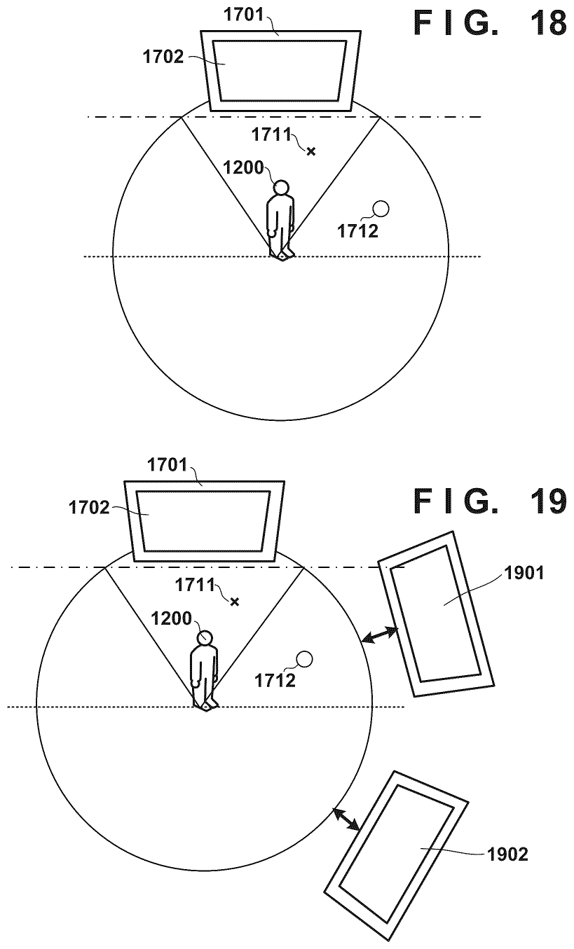

Here, FIG. 18 is an explanatory diagram of a direction of the first avatar after the transition processing according to the second to fifth modifications in relation to the transition from the second mode to the first mode. A direction to which the first avatar 1200 faces is a direction indicated by a circle mark 1712, and is not a direction indicated by a cross mark 1711, which is a direction that a wall area 1701 in the virtual space and an image display area 1702, which is a predetermined area, are present.

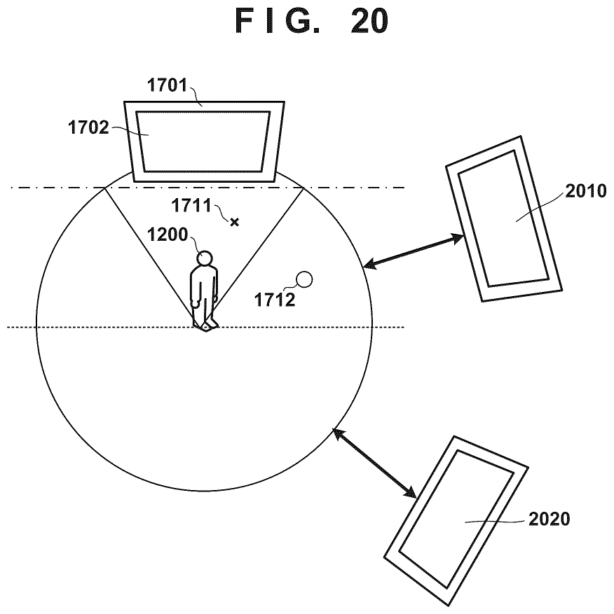

In addition, regarding the first avatar 1200 after the transition processing according to the second to fifth modifications, as illustrated in FIG. 19, at least one or more other content display areas 1901 and 1902 may be further displayed in the direction that the first avatar 1200 faces. Further, as illustrated in FIG. 20, at least one or more other content display areas 2010 and 2020 may be further displayed. In FIG. 19, the other content display areas 1901 and 1902 are respectively displayed in positions close to the first avatar 1200. In FIG. 20, the other content display areas 1901 and 1902 are respectively displayed in positions farther from the first avatar 1200. The display position of another content display area may be farther, as the moving speed of the first avatar 1200 increases, and may be closer, as the moving speed of the first avatar 1200 decreases. That is, the position of another content display area may be controlled so that the distance from the first avatar 1200 to another content display area increases, as the moving speed of the first avatar 1200 increases. Accordingly, it becomes possible to suppress the first avatar after the transition from excessively getting close to another content display area.

Note that the processing of displaying one or more other content display areas in the direction that the avatar in the virtual space faces, as illustrated in FIGS. 19 and 20, is not limited to the cases of the second to fifth modifications. In a case where the second mode for displaying the real viewpoint video of the second avatar (the avatar robot 20) in the real space is transitioned to the first mode for displaying the virtual video of the virtual space, one or more other content display areas may be controlled to face in a direction that the avatar in the virtual space faces.

[Third Modification (Transition from Second Mode to First Mode)]

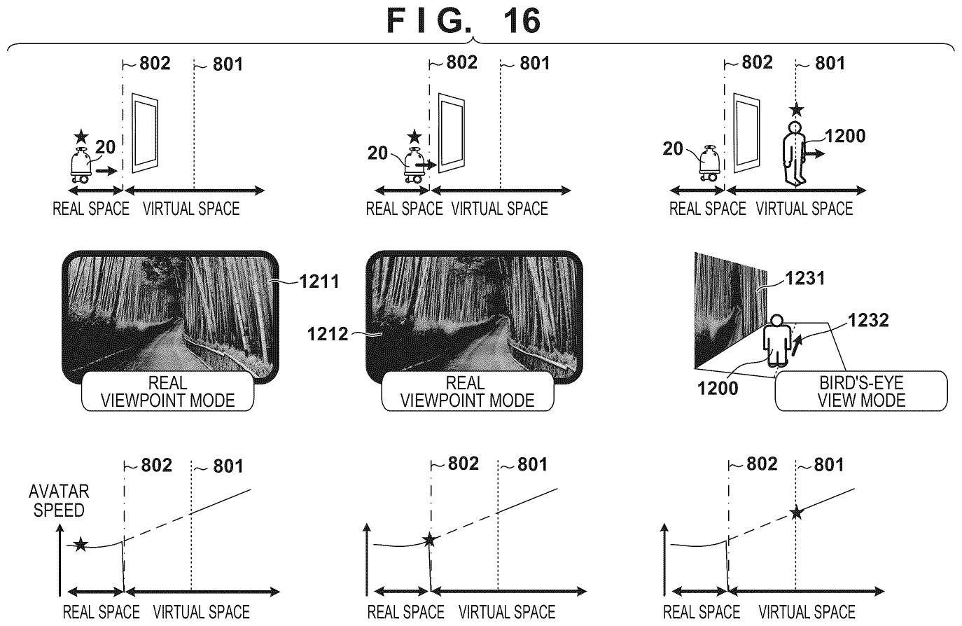

FIG. 15 is an explanatory diagram of transition processing from the second avatar in the real space to the first avatar in the virtual space according to a third modification. A display method of the virtual video in the third one from the left in the middle row of FIG. 15 is different from that in FIG. 14. In the example of FIG. 14, the example of displaying the virtual video in the bird's-eye view mode of the first mode has been described. However, the virtual video may be displayed in the virtual viewpoint mode of the first mode as illustrated in FIG. 15.

[Fourth Modification (Transition from Second Mode to First Mode)]

FIG. 16 is an explanatory diagram of transition processing from the second avatar in the real space to the first avatar in the virtual space according to a fourth modification. In FIG. 16, unlike the examples of FIGS. 14 and 15, a motion is made to cause the avatar robot 20 to get close to the position 802, while accelerating the avatar robot 20. The second mode is switched to the first mode in response to the avatar robot 20 having gotten close to and reached the position 802. The avatar robot 20 automatically stops in response to having reached the position 802. Then, when transitioning to the first avatar 1200 in the virtual space is performed, a direction 1232 of the virtual viewpoint of the virtual video is controlled not to face toward the wall area that is the display area of a real viewpoint video 1231. Then, the first avatar 1200 determines the moving speed of the first avatar 1200 after the transition, based on the acceleration and the speed while the avatar robot 20 has been accelerated. That is, in a case where the acceleration has been performed before the transition, the first avatar 1200 is moved in a state in which the acceleration has been reflected. Accordingly, it becomes possible to prevent from suddenly getting close to the real viewpoint video 1231 after the transition to the first avatar 1200 is performed, while maintaining an avatar operation feeling before and after the transition.

[Fifth Modification (Transition from Second Mode to First Mode)]

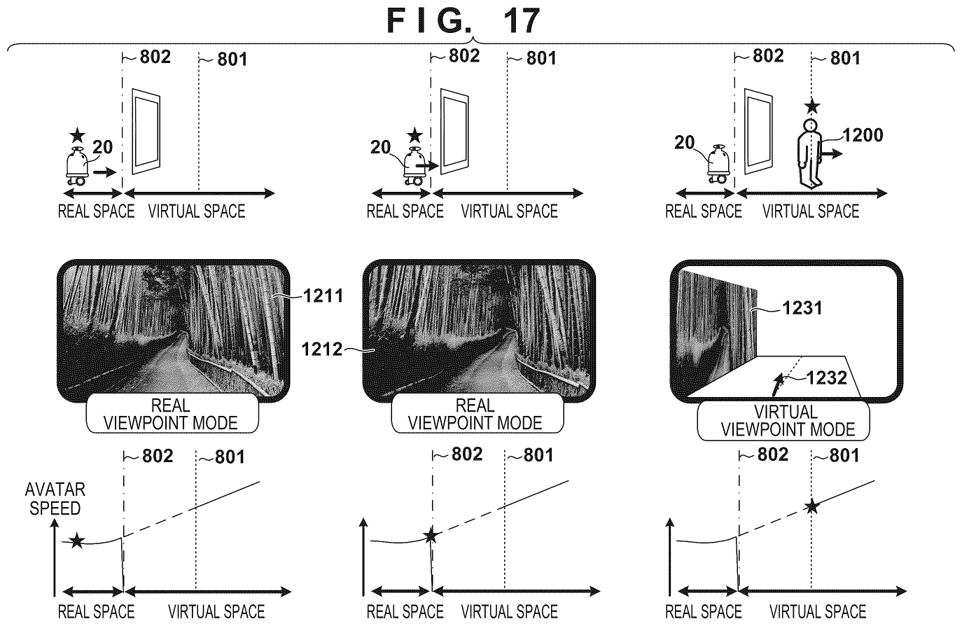

FIG. 17 is an explanatory diagram of transition processing from the second avatar in the real space to the first avatar in the virtual space according to a fifth modification. A display method of the virtual video in the third one from the left in the middle row of FIG. 17 is different from that in FIG. 16. In the example of FIG. 16, the example of displaying the virtual video in the bird's-eye view mode of the first mode has been described. However, the virtual video may be displayed in the virtual viewpoint mode of the first mode as illustrated in FIG. 17.

In addition, in the above-described embodiments, the description has been given assuming that a predetermined area of the virtual video is at least a partial area or the entire area of the wall area in the virtual space. However, the present invention is not limited to this example. For example, the predetermined area of the virtual video may be a display area on a frame imitating a display suspended in the virtual space. Therefore, the predetermined area may be at least a partial area in the virtual space. Further, similarly, another content display area may be at least a partial area or the entire area of the wall area, or may be a display area on a frame imitating a display suspended in the virtual space. Therefore, another content display area may be at least a partial area in the virtual space.

### OTHER EMBODIMENTS

In addition, a program for achieving one or more functions that have been described in each of the embodiments is supplied to a system or an apparatus through a network or via a storage medium, and one or more processors on a computer of the system or the apparatus are capable of reading and executing the program. The present invention is also achievable by such an aspect.

### Summary of Embodiments

1. The information processing apparatus (10) according to the above embodiments is an information processing apparatus comprising:
a control unit (1003) configured to control behavior of either a first avatar (800, 1200) that is an avatar in a virtual space or a second avatar that is an avatar robot (20) in a real space, based on a user operation; and
a switching unit (1005) configured to switch between a first mode for displaying a virtual video of the virtual space and a second mode for displaying a real viewpoint video of the second avatar in the real space, based on the user operation.

Accordingly, the user is able to easily switch between avatars to be used.

2. The information processing apparatus (10) according to the above embodiments further comprising
a display control unit (1004) configured to cause a display device (30) to display either the virtual video or the real viewpoint video, wherein
the display control unit superimposes and displays an image (811) of a place where the second avatar is present on a predetermined area (810) of the virtual video in the first mode, and
in a case where a specific motion is made for the predetermined area, based on the user operation, the switching unit switches from the first mode to the second mode.

Accordingly, by simply making a specific motion in the virtual space, the user is able to easily switch from the virtual video to the real viewpoint video.

3. In the information processing apparatus (10) according to the above embodiments,
the specific motion includes a motion to cause the first avatar to get close to a position (802) of the predetermined area.

Accordingly, by making a motion to move the avatar in the virtual space, the user is able to easily switch from the virtual video to the real viewpoint video.

4. In the information processing apparatus according to the above embodiments,
the specific motion includes a motion to cause the first avatar to get close to the position of the predetermined area to have a threshold distance (to a position 801) (FIG. 10 and FIG. 11).

Accordingly, by making a motion to move the avatar in the virtual space, the user is able to easily switch from the virtual video to the real viewpoint video.

5. In the information processing apparatus (10) according to the above embodiments,
in a case where the specific motion is made, the display control unit changes display content of the predetermined area from the image (811) of the place where the second avatar is present to a real viewpoint video (812, 833) of at least a partial area of the real viewpoint video (812, 833) of the second avatar (FIG. 8˜FIG. 11).

Accordingly, it is possible to recognize the real viewpoint video of the place where the avatar robot is present, and thus expectations for virtual experience using the avatar robot 20 can be increased.

6. In the information processing apparatus (10) according to the above embodiments,
in a case where the switching unit switches from the first mode to the second mode, the display control unit causes the display device to display the real viewpoint video (833) of the second avatar including the real viewpoint video (832) of at least the partial area, without changing a display position of the real viewpoint video (832) of at least the partial area displayed in the predetermined area (FIG. 10 and FIG. 11).

Accordingly, it is possible to suppress the field of view from largely changing from the real viewpoint video of a partial area, and thus it becomes possible to avoid giving the user a sense of incongruity at the time of mode transition.

7. In the information processing apparatus (10) according to the above embodiments,
the predetermined area is at least a partial area (810) in the virtual space.

Accordingly, by simply making a motion to cause the first avatar in the virtual space to get close to the specific area, it becomes possible to achieve mode switching.

8. In the information processing apparatus (10) according to the above embodiments,
the first mode includes a bird's-eye view mode for displaying the virtual video including the first avatar and a virtual viewpoint mode for displaying the virtual video viewed from a virtual viewpoint of the first avatar, and
the information processing apparatus further comprises
a second switching unit (1005) configured to switch from the bird's-eye view mode to the virtual viewpoint mode, in a case where the specific motion is made in the bird's-eye view mode in the first mode (FIG. 8).

Accordingly, a change in the field of view, when the first mode is switched to the second mode, can be reduced.

9. In the information processing apparatus (10) according to the above embodiments,
the first mode includes a bird's-eye view mode for displaying the virtual video including the first avatar and a virtual viewpoint mode for displaying the virtual video viewed from a virtual viewpoint of the first avatar, and
the information processing apparatus further comprises
a third switching unit (1005) configured to switch between the bird's-eye view mode and the virtual viewpoint mode, based on an instruction from a user in the first mode.

Accordingly, it is possible to freely switch between the bird's-eye view mode and the virtual viewpoint mode in accordance with a user's preference.

10. In the information processing apparatus (10) according to the above embodiments,
the control unit causes the first avatar to stop moving, in a case where the first avatar gets close to the predetermined area to have the threshold distance (FIG. 10 and FIG. 11).

Accordingly, it becomes possible to transition to the avatar robot 20 in response to an additional operation (for example, a button press or an instruction to further move the first avatar toward a predetermined area) that has been received from the user in this state.

11. The information processing apparatus (10) according to the above embodiments, further comprising
a display control unit (1004) configured to cause a display device (30) worn by a user to display either the virtual video or the real viewpoint video, wherein
the switching unit switches from the second mode to the first mode, in a case where a specific motion is made, based on the user operation.

Accordingly, by simply making a specific motion in the virtual space, the user is able to easily switch from the real viewpoint video to the virtual video.

12. In the information processing apparatus (10) according to the above embodiments,
the display control unit displays the real viewpoint video (1211) of the second avatar in the second mode, and
in a case where the specific motion is made and the second mode is switched to the first mode, the display control unit superimposes a real viewpoint (1213) video of at least a partial area of the real viewpoint video of the second avatar on a predetermined area of the virtual video, and displays the virtual video (FIG. 12).

Accordingly, it is possible to suppress the field of view from largely changing from the real viewpoint video that has been displayed, and thus it becomes possible to avoid giving the user a sense of incongruity at the time of mode transition.

13. In the information processing apparatus (10) according to the above embodiments,
the first mode includes a bird's-eye view mode for displaying the virtual video including the first avatar and a virtual viewpoint mode for displaying the virtual video viewed from a virtual viewpoint of the first avatar, and
in a case where the specific motion is made and the second mode is switched to the first mode, the display control unit superimposes a real viewpoint video of at least the partial area on a predetermined area of the virtual video in the virtual viewpoint mode, and displays the virtual video (FIG. 13, FIG. 15 and FIG. 17).

Accordingly, it is possible to easily recognize the transition from the real viewpoint video of the real space to the virtual video of the virtual space.

14. In the information processing apparatus (10) according to the above embodiments,
the display control unit causes the virtual video to be displayed such that the first avatar does not face the predetermined area in the virtual viewpoint mode (FIG. 13, FIG. 15, FIG. 17 and FIG. 18).

Accordingly, in a case where the real viewpoint video of the real space is transitioned to the virtual space, it is possible to avoid a situation in which the real viewpoint video before the transition enters the field of view, and thus it becomes possible to perform transition that avoids giving the user a sense of incongruity.

15. In the information processing apparatus (10) according to the above embodiments,
the first mode includes a bird's-eye view mode for displaying the virtual video including the first avatar and a virtual viewpoint mode for displaying the virtual video viewed from a virtual viewpoint of the first avatar, and
in a case where the specific motion is made and the second mode is switched to the first mode, the display control unit superimposes a real viewpoint video of at least the partial area on a predetermined area of the virtual video in the bird's-eye view mode, and displays the virtual video (FIG. 12, FIG. 14 and FIG. 16).

Accordingly, it is possible to easily recognize the transition from the real viewpoint video of the real space to the virtual video of the virtual space.

16. In the information processing apparatus (10) according to the above embodiments,
the display control unit causes the virtual video to be displayed such that the first avatar does not face the predetermined area in the bird's-eye view mode (FIG. 12, FIG. 14, FIG. 16 and FIG. 18).

Accordingly, in a case where the real viewpoint video of the real space is transitioned to the virtual space, it is possible to avoid a situation in which the real viewpoint video before the transition enters the field of view, and thus it becomes possible to perform transition that avoids giving the user a sense of incongruity.

17. In the information processing apparatus (10) according to the above embodiments,
the specific motion includes a motion to cause the second avatar to get close to a boundary of a movable area in the real space.

Accordingly, by simply performing an operation of moving the avatar robot 20, which is the second avatar, it is possible to switch between the modes.

18. In the information processing apparatus (10) according to the above embodiments,
in a case where the specific motion is made and the second mode is switched to the first mode, the control unit controls a movement of the first avatar, based on a moving speed and a moving acceleration of the second avatar (FIG. 14, FIG. 15, FIG. 16 and FIG. 17).

Accordingly, it is possible to maintain continuity of the user operation before and after the mode switching, and thus it becomes possible to improve the operability.

19. In the information processing apparatus (10) according to the above embodiments,
the display control unit causes another content display area (1901, 1902, 2010, 2020) to be displayed in the virtual video together with the predetermined area, and
in a case where the specific motion is made and the second mode is switched to the first mode, the display control unit controls a position of the another content display area with respect to the first avatar, based on a moving speed of the first avatar.

Accordingly, it is possible to display another content display area at an appropriate position where it is easy for the user to visually recognize.

20. In the information processing apparatus (10) according to the above embodiments,
the display control unit controls the position of the another content display area such that a distance from the first avatar to the another content display area increases, as the moving speed of the first avatar increases.

Accordingly, when the mode is switched to the first mode, it is possible to prevent the avatar in the virtual space from suddenly getting close to another content display area.

21. The method for controlling an information processing apparatus (10) according to the above embodiments is a method for controlling an information processing apparatus, the method comprising:
a control step of controlling behavior of either a first avatar that is an avatar in a virtual space or a second avatar that is an avatar robot in a real space, based on a user operation; and
a switching step of switching between a first mode for displaying a virtual video of the virtual space and a second mode for displaying a real viewpoint video of the second avatar in the real space, based on the user operation.

Accordingly, it becomes possible to easily switch between the avatars to be used by the user.

22. The program according to the above embodiments is a program for causing a computer to execute the method for controlling the information processing apparatus according to the above embodiments.

Accordingly, the functions of the information processing apparatus are achievable as a program.

23. The storage medium according to the above embodiments is a non-transitory computer-readable storage medium storing a program for causing a computer to execute the method for controlling the information processing apparatus according to the above embodiments.

Accordingly, the functions of the information processing apparatus are achievable as a storage medium.

According to the present invention, it becomes possible to easily switch between the avatars to be used by the user.

The invention is not limited to the foregoing embodiments, and various variations/changes are possible within the spirit of the invention.

What is claimed is:

1. An information processing apparatus comprising:
a control unit configured to control behavior of either a first avatar that is an avatar in a virtual space or a second avatar that is an avatar robot in a real space, based on a user operation; and
a switching unit configured to switch between a first mode for displaying a virtual video of the virtual space and a second mode for displaying a real viewpoint video of the second avatar in the real space, based on the user operation.

2. The information processing apparatus according to claim 1, further comprising
a display control unit configured to cause a display device to display either the virtual video or the real viewpoint video, wherein
the display control unit superimposes and displays an image of a place where the second avatar is present on a predetermined area of the virtual video in the first mode, and
in a case where a specific motion is made for the predetermined area, based on the user operation, the switching unit switches from the first mode to the second mode.

3. The information processing apparatus according to claim 2, wherein the specific motion includes a motion to cause the first avatar to get close to a position of the predetermined area.

4. The information processing apparatus according to claim 2, wherein the specific motion includes a motion to cause the first avatar to get close to the position of the predetermined area to have a threshold distance.

5. The information processing apparatus according to claim 2, wherein in a case where the specific motion is made, the display control unit changes display content of the predetermined area from the image of the place where the second avatar is present to a real viewpoint video of at least a partial area of the real viewpoint video of the second avatar.

6. The information processing apparatus according to claim 5, wherein in a case where the switching unit switches from the first mode to the second mode, the display control unit causes the display device to display the real viewpoint video of the second avatar including the real viewpoint video of at least the partial area, without changing a display position of the real viewpoint video of at least the partial area displayed in the predetermined area.

7. The information processing apparatus according to claim 2, wherein the predetermined area is at least a partial area in the virtual space.

8. The information processing apparatus according to claim 2, wherein
the first mode includes a bird's-eye view mode for displaying the virtual video including the first avatar and a virtual viewpoint mode for displaying the virtual video viewed from a virtual viewpoint of the first avatar, and
the information processing apparatus further comprises
a second switching unit configured to switch from the bird's-eye view mode to the virtual viewpoint mode, in a case where the specific motion is made in the bird's-eye view mode in the first mode.

9. The information processing apparatus according to claim 1, wherein
the first mode includes a bird's-eye view mode for displaying the virtual video including the first avatar and a virtual viewpoint mode for displaying the virtual video viewed from a virtual viewpoint of the first avatar, and
the information processing apparatus further comprises
a third switching unit configured to switch between the bird's-eye view mode and the virtual viewpoint mode, based on an instruction from a user in the first mode.

10. The information processing apparatus according to claim 4, wherein the control unit causes the first avatar to stop moving, in a case where the first avatar gets close to the predetermined area to have the threshold distance.

11. The information processing apparatus according to claim 1, further comprising
a display control unit configured to cause a display device worn by a user to display either the virtual video or the real viewpoint video, wherein
the switching unit switches from the second mode to the first mode, in a case where a specific motion is made, based on the user operation.

12. The information processing apparatus according to claim 11, wherein
the display control unit displays the real viewpoint video of the second avatar in the second mode, and
in a case where the specific motion is made and the second mode is switched to the first mode, the display control unit superimposes a real viewpoint video of at least a partial area of the real viewpoint video of the second avatar on a predetermined area of the virtual video, and displays the virtual video.

13. The information processing apparatus according to claim 12, wherein
the first mode includes a bird's-eye view mode for displaying the virtual video including the first avatar and a virtual viewpoint mode for displaying the virtual video viewed from a virtual viewpoint of the first avatar, and
in a case where the specific motion is made and the second mode is switched to the first mode, the display control unit superimposes a real viewpoint video of at least the partial area on a predetermined area of the virtual video in the virtual viewpoint mode, and displays the virtual video.

14. The information processing apparatus according to claim 13, wherein the display control unit causes the virtual video to be displayed such that the first avatar does not face the predetermined area in the virtual viewpoint mode.

15. The information processing apparatus according to claim 12, wherein
the first mode includes a bird's-eye view mode for displaying the virtual video including the first avatar and a virtual viewpoint mode for displaying the virtual video viewed from a virtual viewpoint of the first avatar, and
in a case where the specific motion is made and the second mode is switched to the first mode, the display control unit superimposes a real viewpoint video of at least the partial area on a predetermined area of the virtual video in the bird's-eye view mode, and displays the virtual video.

16. The information processing apparatus according to claim 15, wherein the display control unit causes the virtual video to be displayed such that the first avatar does not face the predetermined area in the bird's-eye view mode.

17. The information processing apparatus according to claim 11, wherein the specific motion includes a motion to cause the second avatar to get close to a boundary of a movable area in the real space.

18. The information processing apparatus according to claim 11, wherein in a case where the specific motion is made and the second mode is switched to the first mode, the control unit controls a movement of the first avatar, based on a moving speed and a moving acceleration of the second avatar.

19. The information processing apparatus according to claim 12, wherein
the display control unit causes another content display area to be displayed in the virtual video together with the predetermined area, and
in a case where the specific motion is made and the second mode is switched to the first mode, the display control unit controls a position of the another content display area with respect to the first avatar, based on a moving speed of the first avatar.

20. The information processing apparatus according to claim 19, wherein the display control unit controls the position of the another content display area such that a distance from the first avatar to the another content display area increases, as the moving speed of the first avatar increases.

21. A method for controlling an information processing apparatus, the method comprising:
controlling behavior of either a first avatar that is an avatar in a virtual space or a second avatar that is an avatar robot in a real space, based on a user operation; and
switching between a first mode for displaying a virtual video of the virtual space and a second mode for displaying a real viewpoint video of the second avatar in the real space, based on the user operation.

22. A non-transitory computer-readable storage medium storing a program for causing a computer to execute a method for controlling an information processing apparatus, the method comprising:
controlling behavior of either a first avatar that is an avatar in a virtual space or a second avatar that is an avatar robot in a real space, based on a user operation; and
switching between a first mode for displaying a virtual video of the virtual space and a second mode for displaying a real viewpoint video of the second avatar in the real space, based on the user operation.
